(19) United States
(12) Patent Application Publication
(10) Pub. No.: US 2024/0387872 A1
(43) Pub. Date: Nov. 21, 2024

(54) ELECTROLYTE AND SECONDARY BATTERY

(71) Applicant: TOYOTA JIDOSHA KABUSHIKI KAISHA, Aichi-ken (JP)

(72) Inventor: Kyosuke YOSHIDA, Susono-shi (JP)

(21) Appl. No.: 18/661,713

(22) Filed: May 13, 2024

(30) Foreign Application Priority Data
May 15, 2023 (JP) 2023-080428

(51) Int. Cl. H01M 10/0568; H01M 4/02; H01M 4/38

(52) U.S. Cl. CPC H01M 10/0568; H01M 4/386; H01M 2004/027

(57) ABSTRACT

An electrolyte includes a lithium imide salt and an ionic liquid, and a molar ratio of the ionic liquid to the lithium imide salt (ionic liquid/lithium imide salt) is 1.5 or lower.

### CROSS-REFERENCE TO RELATED APPLICATION

This application is based on and claims priority under 35 USC 119 from Japanese Patent Application No. 2023-080428, filed on May 15, 2023, the disclosure of which is incorporated by reference herein.

### BACKGROUND

### Technical Field

The present disclosure relates to an electrolyte and a secondary battery.

### Related Art

In recent years, development of secondary batteries employing electrolytes containing flame-retardant ionic liquids has progressed. For example, Japanese Patent Application Laid-open (JP-A) No. 2012-204133 discloses a non-aqueous electrolyte lithium ion battery that includes a positive electrode, a negative electrode, a separator, and a non-aqueous electrolyte containing a lithium salt and an ionic liquid (see claim 1 and paragraph of JP-A No. 2012-204133).

### SUMMARY OF INVENTION

However, in a case in which an electrolyte containing an ionic liquid is used in a secondary battery including a separator, charging and discharging cause cracking in the solid electrolyte interphase (SEI) film formed at the interface between the electrolyte and the active material layer, and a new SEI film is formed at this crack. Since, as a result, liquid decomposition of the electrolyte progresses and a thick film is formed, the reaction resistance value at the interface between the electrolyte and the active material layer tends to increase, and the capacity retention rate tends to decrease. In view of the above circumstances, the present disclosure addresses provision of an electrolyte that curbs an increase in reaction resistance at an interface between the electrolyte and an active material layer, and a secondary battery including the same.

Aspects according to the present disclosure include the following aspects.

<1> An electrolyte, including a lithium imide salt and an ionic liquid, in which a molar ratio of the ionic liquid to the lithium imide salt (ionic liquid/lithium imide salt) is 1.5 or lower.

<2> The electrolyte of <1>, in which both of the lithium imide salt and the ionic liquid include a bis (fluorosulfonyl) amide ion (FSA) as an anionic species.

<3> The electrolyte of <1> or <2>, in which the ionic liquid includes 1-ethyl-3-methylimidazolium (EMIM) as a cationic species.

<4> A secondary battery, including: a positive electrode layer; a negative electrode layer; and a separator layer including the electrolyte of any one of the foregoing <1> to <3> and disposed between the positive electrode layer and the negative electrode layer.

<5> The secondary battery of <4>, in which the negative electrode layer includes an Si-based active material as a negative electrode active material.

The present disclosure provides an electrolyte that curbs an increase in reaction resistance at an interface between the electrolyte and an active material layer, and a secondary battery including the same.

### BRIEF DESCRIPTION OF THE DRAWINGS

FIG. 1 is a schematic cross-sectional view illustrating one embodiment of a secondary battery of the present disclosure.

### MODE FOR CARRYING OUT INVENTION

Explanation follows regarding an exemplary embodiment of the present disclosure. These descriptions and examples are illustrative of embodiments, and do not limit the scope of the invention.

In numerical ranges set forth stepwise in the specification, the upper limit or lower limit set forth in a single numerical range may be replaced by an upper limit or lower limit set forth in another numerical range in the stepwise description. In the numerical ranges described in the present specification, the upper limit value or the lower limit value of a numerical range may be replaced with a value illustrated in an example.

Each component may contain plural kinds of relevant substances.

In cases in which there are plural types of substances corresponding to a component in the composition, reference to the amount of the component in the composition means the total amount of the plural substances present in the composition, unless otherwise specified.

### [Electrolyte]

An electrolyte according to the present disclosure is an electrolyte including a lithium imide salt and an ionic liquid, in which a molar ratio of the ionic liquid to the lithium imide salt (ionic liquid/lithium imide salt) is 1.5 or lower.

The electrolyte according to the present disclosure has the above configuration, enabling an increase in reaction resistance at the interface between the electrolyte and the active material layer to be reduced. The mechanism of action is not necessarily clear, but we infer that the mechanism may be as follows.

By setting the molar ratio of ionic liquid to lithium imide salt in the electrolyte within the above range, the viscosity of the electrolyte is increased, enabling an increase in resistance resulting from outflow of the ionic liquid from the electrode to be reduced. We surmise that an increase in reaction resistance at the interface between the electrolyte and the active material layer can be curbed by increasing the concentration of lithium imide salt in the ionic liquid, even though ionic liquid is conventionally considered to have low ionic conductivity,.

The electrolyte according to the present disclosure can be used for both a positive electrode and a negative electrode. In particular, since the electrolyte contains an ionic liquid, the electrolyte is softer than an electrolyte that does not contain an ionic liquid. Therefore, the electrolyte according to the present disclosure this is useful for a solid-state battery including an electrode including an active material that easily expands and contracts (such as a negative electrode; more specifically, a negative electrode containing silicon).

### [Lithium Imide Salt]

An electrolyte according to the present disclosure includes a lithium imide salt. Examples of lithium imide salts include lithium bis(trifluoromethanesulfonyl) imide (LiTFSA), lithium bis(fluorosulfonyl)imide (LiFSA), lithium difluoro(oxalato)borate (LiDFOB), and lithium bis(oxalato)borate (LiBOB). One lithium imide salt may be used singly, or a combination of two or more lithium imide salts may be used.

Among the above, the lithium imide salt preferably includes a bis(fluorosulfonyl)amide ion (FSA) as an anionic species, and it is more preferable that lithium bis(fluorosulfonyl)imide (LiFSA) is contained as the lithium imide salt, from the viewpoint of further curbing an increase in reaction resistance at the interface between the electrolyte and the active material layer.

### [Ionic Liquid]

The electrolyte according to the present disclosure includes an ionic liquid. Examples of the ionic liquid include 1-ethyl-3-methylimidazolium bis(fluorosulfonyl imide [EMIM-FSA], N-methyl-N-propylpyrrolidinium bis(fluorosulfonyl)imide [PP13-FSA], cesium bis(fluorosulfonyl)imide [CsFSA], N,N-diethyl-N-methyl-N-(2-methoxyethyl)ammonium bis(fluorosulfonyl)imide (DEMEFSA), N-methyl-N-propylpyrrolidinium bis(trifluoromethanesulfonyl)amide (PP13TFSA), cesium bis(trifluoromethylsulfonyl)amide (CsTFSA), and N,N-diethyl-N-methyl-N-(2-methoxyethyl)ammonium bis(trifluoromethanesulfonyl)amide (DEMETFSA). One type of ionic liquid may be used alone, or a combination of two or more types of ionic liquid may be used.

Among the above, the ionic liquid preferably includes 1-ethyl-3-methylimidazolium (EMIM) as a cationic species, and it is more preferable that 1-ethyl-3-methylimidazolium bis (fluorosulfonyl) imide [EMIM-FSA] is contained as the ionic liquid. EMIM-FSA is preferable from the viewpoints of further curbing an increase in reaction resistance at the interface between the electrolyte and the active material layer by setting the viscosity of the ionic liquid or the like to an appropriate level, and of battery performance.

As described above, from the viewpoint of further curbing an increase in reaction resistance at the interface between the electrolyte and the active material layer, both the lithium imide salt and the ionic liquid in the electrolyte of the present disclosure preferably contain a bis (fluorosulfonyl) amide ion (FSA) as an anionic species.

### [Other Components]

The electrolyte according to the present disclosure may further contain other components as required within a range in which the advantageous effects of the present disclosure are exhibited. Other ingredients include, for example, fillers, binder resins, sulfide solid electrolytes, oxide solid electrolytes, halide solid electrolytes, polymers or rubbers other than the above binder resins, and conductive aids (such as fibrous carbon materials).

There is no particular limitation on the conductive aid as long as it is an ordinary conductive aid usable in lithium ion batteries. Examples of the conductive aid include carbon black such as acetylene black or Ketjen black, and carbon materials such as vapor phase carbon fibers.

The conductive aid is not particularly limited as long as it is a conductive material. For example, it may be a metal such as aluminum, stainless steel (SUS), silver, gold, copper, or titanium. Alternatively, the conductive aid may be carbon such as graphite or carbon black (such as acetylene black, Ketjen black, furnace black, channel black, or thermal lamp black). Alternatively, the conductive aid may be selected from alloys or metallic acids of the metals described above. One conductive aid may be used singly, or a combination of two or more conductive aids may be used. Moreover, the conductive aid is not limited to particles, and may be a so-called filler-type conductive aid such as carbon nanofibers or carbon nanotubes.

### [Content]

The molar ratio of ionic liquid to lithium imide salt (ionic liquid/lithium imide salt) is 1.5 or less. As far as curbing of an increase in reaction resistance at the interface between the electrolyte and the active material layer is possible, this range may slightly be broadened to, for example, 1.55 or less, or 1.56 or less. Alternatively, the molar ratio of ionic liquid to lithium imide salt (ionic liquid/lithium imide salt) may be 1.45 or less, or may be 1.40 or less. Although the lower limit value of the above molar ratio (ionic liquid/lithium imide salt) is not particularly limited, the lower limit value may be a ratio obtained from the amounts when a lithium imide salt is added until saturated. For example, the molar ratio may be 1.0 or more, and more preferably 1.2 or more.

The electrolyte of the present disclosure may contain an organic electrolyte (namely, an organic solvent containing carrier ions suitable for the purpose and having ionic conductivity that transports the ions from one electrode to the other electrode) within a range in which the advantageous effects of the present application are exhibited. For example, the proportion of the organic electrolyte is preferably 10% by mass or less with respect to the total amount of the electrolyte, more preferably, 5% by mass or less, yet more preferably, 3% by mass or less, and most preferably 0% by mass; that is, not included.

### [Secondary Battery]

A secondary battery of the present disclosure includes an electrolyte of the present disclosure. The method of manufacturing the secondary battery is not particularly limited, and known methods of manufacturing a secondary battery can be applied. Examples include the methods described in the examples. A secondary battery of the present disclosure includes, for example, a positive electrode layer, a negative electrode layer, and a separator layer including an electrolyte of the present disclosure and disposed between the positive electrode layer and the negative electrode layer.

Known materials can be used as materials for the separator layer, the positive electrode layer, and the negative electrode layer.

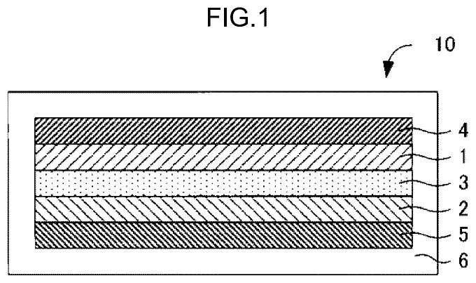

FIG. 1 is a schematic cross-sectional view illustrating one embodiment of the secondary battery of the present disclosure. A battery 10 shown in FIG. 1 includes a positive electrode layer 1 that contains a positive electrode active material, a negative electrode layer 2 that contains a negative electrode active material, a separator layer 3 disposed between the positive electrode layer 1 and the negative electrode layer 2, a positive electrode current collector 4 that collects electric current for the positive electrode layer 1, a negative electrode current collector 5 that collects electric current for the negative electrode layer 2, and an outer casing 6 that accommodates these members. In the secondary battery 10, the separator layer contains the electrolyte of the present disclosure.

In the secondary battery of the present disclosure, the negative electrode layer may contain an Si-based active material as the negative electrode active material. There is no particular limitation on the Si-based active material as long as the Si-based active material includes silicon and can act as an active material. Examples thereof include silicon simple substance particles, silicon alloy particles (such as alloys of Si with one or more metals selected from the group consisting of Sn, Ti, Fe, Ni, Cu, Co, and Al), porous silicon, silicon clathrate compounds, silicon oxides, and any mixture thereof. One Si-based active material may be used singly, or two or more Si-based active materials may be used in combination.

A secondary battery including a negative electrode layer including an Si-based active material has advantages such as having a high capacity and exhibiting a relatively low operating voltage; however, expansion and contraction of the Si-based active material accompanying charging and discharging are larger than expansion and contraction exhibited by other active materials. Accordingly, charging and discharging causes expansion and contraction, which in turn generates cracking in the SEI film formed at the interface between the electrolyte and the active material layer, and an SEI film is newly formed at this cracked portion. As a result, the reaction resistance at the interface between the electrolyte and the active material layer tends to increase. In contrast, in the secondary battery of the present disclosure, since the electrolyte of the present disclosure is included in the separator layer, an increase in reaction resistance at the interface between the electrolyte and the active material layer can be curbed.

The secondary battery of the present disclosure may be a lithium ion secondary battery. Examples of applications of the secondary battery include a vehicle, an electronic device, and a power source such as electric storage.

### EXAMPLES

Examples are described below, but the present invention is not limited in any way to these examples.

### Example 1

Lithium imide salt (LiFSA) was mixed with an ionic liquid (EMIM-FSA) such that the molar ratio (ionic liquid/lithium imide salt) was 1.5:1, and the mixture was stirred at room temperature (23±1° C.) to obtain an electrolyte of Example 1.

### Comparative Example 1

Lithium imide salt (LiFSA) was mixed with an ionic liquid (EMIM-FSA) such that the molar ratio (ionic liquid/lithium imide salt) was 6:1, and the mixture was stirred at room temperature (23±1° C.) to obtain an electrolyte of Comparative Example 1.

### Comparative Example 2

### Case of High Concentration Organic Electrolyte (4M LIFSI/DME+120 vol % TTE)

DME (1,2-dimethoxyethane) was mixed with LiFSA at a molar concentration of 4.0 M, and stirred at room temperature (23±1° C.). Then TTE (1,1,2,2-tetrafluoroethyl-2,2,3,3-tetrafluoropropyl ether) was added so as to attain a volume ratio of 120% to the solution, and the electrolyte of Comparative Example 2 was obtained by stirring at room temperature (23±1° C.).

### Comparative Example 3

### Case of Dilute Organic Electrolyte (1.2 M LiPF6/FEC-EC-DMC-EMC)

FEC (fluoroethylene carbonate), EC (ethylene carbonate), DMC (dimethyl carbonate) and EMC (ethyl methyl carbonate), as solvents, were mixed so as to attain a volume ratio (FEC:EC:DMC:EMC) of 1:2:3:4. Then, LiPF₆ was mixed with the solution so as to have a concentration of 1.2 M, and the mixture was stirred at room temperature (23±1° C.) to obtain an electrolyte of Comparative Example 3.

### <Measurement and Evaluation of Reaction Resistance 1: Case of Porous Si>

SUS foil, porous Si, an aramid-based separator in which the electrolyte of each example is contained, and, as the opposite electrode, Li metal and SUS foil, were layered in this order, and a coin cell (test cell) was prepared using an aluminum laminate as an exterior material.

The secondary batteries of the respective examples were placed in a constant temperature bath at 25° C. Charging was performed until the battery voltage reached 2.2V, and then the AC impedance of the battery was measured, and the battery was discharged so as to attain a state of charge (SOC) of 50%.

The battery was charged at a current rate of ⅓ C with a constant current until the battery voltage reached 2.7V, and then constant-voltage charging was performed, and the charging was ended when the charging current became a value corresponding to 0.01 C.

AC impedance measurement was performed at an AC amplitude of 10 mV and a frequency range of 1 MHz to 10 mHz. The waveform of the arc portion appearing in a Nyquist diagram obtained by AC impedance measurement was subjected to circular fitting to obtain a curve. The difference between the x-axis intercept on the high-frequency side and the low-frequency side of the obtained curve was defined as the initial resistance. The results are shown in Table 1.

### <Measurement and Evaluation of Reaction Resistance 2: Case of Crystalline Si>

A coin cell of each example was manufactured by the same method as in the

Measurement and Evaluation of Reaction Resistance 1, with the exception that the porous Si was replaced by crystalline Si. Then, impedance measurement was performed.

Then, the reaction resistance values derived from the interface between the crystalline Si and the electrolyte solution in the Nyquist diagram obtained by the same method as in Measurement and Evaluation of Reaction Resistance 1 were calculated using circular fitting, and the rate of increase in reaction resistance was determined as (reaction resistance when porous Si was used)/(reaction resistance when crystalline Si was used)×100 (%). The results are shown in Table 1.

TABLE 1

| | | Reaction Resistance Value at | | Rate of |
|---|---|---|---|---|
| | | Interface between Electrolyte | | Increase |
| | Molar Ratio | and Active Material Layer | | of Reaction |
| | (Ionic Liquid/ | (Ω) | | Resistance |
| | Lithium | Evaluation 1 | Evaluation 2 | Value |
| | Imide Salt) | (Porous Si) | (Crystalline Si) | (%) |
| Example 1 | 1.5 | 11 | 10 | 110 |
| Comparative | 6.0 | 19 | 19 | 100 |
| Example 1 | | | | |
| Comparative | 0.0 | 17 | 10 | 170 |
| Example 2 | | | | |
| Comparative | 0.0 | 41 | 23 | 178 |
| Example 3 | | | | |

As shown in Table 1, the reaction resistance values of the electrolytes of the examples were kept lower, even in porous Si which has a larger specific surface area, than the electrolytes of the comparative examples, and it was found that an increase in reaction resistance at the interface between the electrolyte and the active material layer was curbed.

What is claimed is:

1. An electrolyte, comprising a lithium imide salt and an ionic liquid, wherein a molar ratio of the ionic liquid to the lithium imide salt (ionic liquid/lithium imide salt) is 1.5 or lower.

2. The electrolyte of claim 1, wherein both of the lithium imide salt and the ionic liquid comprise a bis (fluorosulfonyl) amide ion (FSA) as an anionic species.

3. The electrolyte of claim 1, wherein the ionic liquid includes 1-ethyl-3-methylimidazolium (EMIM) as a cationic species.

4. A secondary battery, comprising:
a positive electrode layer;
a negative electrode layer; and
a separator layer including the electrolyte of claim 1 and disposed between the positive electrode layer and the negative electrode layer.

5. The secondary battery of claim 4, wherein the negative electrode layer includes an Si-based active material as a negative electrode active material.
